(19) United States
(12) Patent Application Publication
(10) Pub. No.: US 2025/0102030 A1
(43) Pub. Date: Mar. 27, 2025

(54) BRAKE PISTON AND BRAKE SYSTEM INCLUDING THE SAME

(71) Applicant: HL MANDO CORPORATION, Pyeongtaek (KR)

(72) Inventor: Hatem SHAHIN, Pfaffenhofen (DE)

(21) Appl. No.: 18/607,572

(22) Filed: Mar. 18, 2024

(30) Foreign Application Priority Data
Sep. 27, 2023 (DE) 102023209432.0

(51) Int. Cl. F16D 65/18; F16D 55/226; F16D 125/04; F16D 125/06

(52) U.S. Cl. CPC F16D 65/18; F16D 55/226; F16D 2125/04; F16D 2125/06

(57) ABSTRACT

According to an aspect of the disclosure, there is provided a brake piston provided in a brake system of a vehicle and pressing a brake pad to a disc by braking hydraulic pressure, the brake piston including: a body portion installed in a cylinder provided in a caliper housing, being in a shape of a pillar, and configured to be movable forward and backward, wherein the body portion includes: a first body portion provided at an outer side of the body portion in a radial direction of the disc; and a second body portion provided at an inner side of the body portion in the radial direction of the disc and having a coefficient of elasticity that is different from a coefficient of elasticity of the first body portion.

### CROSS-REFERENCE TO RELATED APPLICATION

This application claims the benefit of German Patent Application No. 102023209432.0, filed on Sep. 27, 2023 in the German Patent Office (DPMA), the disclosures of which are incorporated herein by reference in its entirety.

### BACKGROUND

### 1. Field

The disclosure relates to a brake piston and a brake system including the same, and more particularly, to a brake piston having different characteristics according to its parts to be prevented from being twisted upon braking, and a brake system including the brake piston.

### 2. Description of the Related Art

In general, in a hydraulic brake system, a piston provided in a cylinder moves forward and backward by braking hydraulic pressure provided from a master cylinder or a hydraulic pressure generator to press a brake pad to a brake disc, and a braking force is generated by friction between the brake pad and the brake disc.

In the case of a floating caliper disc brake system, a piston provided in one side of a caliper housing moves forward and backward to press an inner brake pad, and a finger portion provided in the other side of the caliper housing presses an outer brake pad by a reaction force caused by the pressure.

At this time, a problem arises in that the piston pressing the brake pad is twisted to one side inside the cylinder due to deformation of the caliper housing and the rotation of the disc. When the piston moving forward and backward in the axial direction inside the cylinder is twisted, the piston contacts the inner wall of the cylinder to damage the inner wall of the cylinder and fails to properly press the brake pad, which causes unstable braking.

### SUMMARY

It is an aspect of the disclosure to provide a brake piston having different characteristics according to its parts to be prevented from being twisted upon braking, and a brake system including the brake piston.

Additional aspects of the disclosure will be set forth in part in the description which follows and, in part, will be obvious from the description, or may be learned by practice of the disclosure.

In accordance with an aspect of the disclosure, a brake piston provided in a brake system of a vehicle and pressing a brake pad to a disc by braking hydraulic pressure, includes: a body portion installed in a cylinder provided in a caliper housing, being in a shape of a pillar, and configured to be movable forward and backward, wherein the body portion includes: a first body portion provided at an outer side of the body portion in a radial direction of the disc; and a second body portion provided at an inner side of the body portion in the radial direction of the disc and having a coefficient of elasticity that is different from a coefficient of elasticity of the first body portion.

The first body portion may be bonded with the second body portion to form the body portion.

The first body portion and the second body portion may be made of different materials.

A cross sectional area of the first body portion in an axial direction may be different from a cross sectional area of the second body portion in the axial direction.

The coefficient of elasticity of the first body portion may be greater than the coefficient of elasticity of the second body portion.

The body portion may further include a third body portion positioned between the first body portion and the second body portion.

The first body portion and the second body portion may be bonded with the third body portion to form the body portion.

A coefficient of elasticity of the third body portion may be different from the coefficients of elasticity of the first body portion and the second body portion.

The coefficient of elasticity of the first body portion may be greater than the coefficient of elasticity of the third body portion, and the coefficient of elasticity of the third body portion may be greater than the coefficient of elasticity of the second body portion.

The first body portion, the second body portion, and the third body portion may be made of different materials.

In accordance with an aspect of the disclosure, a brake system includes: a carrier in which a pair of brake pads are installed to be movable forward and backward; a caliper housing slidably installed in the carrier, wherein a cylinder is provided in the caliper housing; and a piston installed in the cylinder and configured to be movable forward and backward, wherein the piston includes a body portion being in a shape of a pillar, and the body portion includes: a first body portion provided at an outer side of the body portion in a radial direction of the disc; and a second body portion provided at an inner side of the body portion in the radial direction of the disc and having a coefficient of elasticity that is different from a coefficient of elasticity of the first body portion.

The first body portion may be bonded with the second body portion to form the body portion.

The first body portion and the second body portion may be made of different materials.

A cross sectional area of the first body portion in an axial direction may be different from a cross sectional area of the second body portion in the axial direction.

The coefficient of elasticity of the first body portion may be greater than the coefficient of elasticity of the second body portion.

The body portion may further include a third body portion positioned between the first body portion and the second body portion.

The first body portion and the second body portion may be bonded with the third body portion to form the body portion.

A coefficient of elasticity of the third body portion may be different from the coefficients of elasticity of the first body portion and the second body portion.

The coefficient of elasticity of the first body portion may be greater than the coefficient of elasticity of the third body portion, and the coefficient of elasticity of the third body portion may be greater than the coefficient of elasticity of the second body portion.

The first body portion, the second body portion, and the third body portion may be made of different materials.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 schematically shows a brake system according to an embodiment of the disclosure;

FIG. 2 schematically shows a cross section in vertical direction of a brake piston according to a first embodiment of the disclosure;

FIG. 3 schematically shows a cross section in horizontal direction A-A of the brake piston according to the first embodiment of the disclosure;

FIG. 4 schematically shows a cross section in vertical direction of a brake piston according to a second embodiment of the disclosure;

FIG. 5 schematically shows a cross section in horizontal direction B-B of the brake piston according to the second embodiment of the disclosure;

FIG. 6 schematically shows a cross section in vertical direction of a brake piston according to a third embodiment of the disclosure; and

FIG. 7 schematically shows a cross section in horizontal direction C-C of the brake piston according to the third embodiment of the disclosure.

### DETAILED DESCRIPTION

Like reference numerals refer to like components throughout the specification. This specification does not describe all the components of the embodiments, and duplicative contents between general contents or embodiments in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a certain part is referred to as being “connected” to another part, it includes not only a direct connection but also an indirect connection, and the indirect connection includes connecting through a wireless network.

Also, when it is described that a certain part “includes” a component, it means that the component may further include other components, not excluding the other components unless specifically stated otherwise.

The terms ‘first,’ ‘second,’ etc. are used to distinguish one component from another component, and the components are not limited by the above-mentioned terms.

The singular forms “a,” “an,” and “the” include plural referents unless the context clearly dictates otherwise.

In each operation, an identification numeral is used for convenience of explanation, the identification numeral does not describe the order of the operation, and the operation may be performed differently from the order specified unless the context clearly states a particular order.

Hereinafter, an operation principle and embodiments of the disclosure will be described with reference to the accompanying drawings.

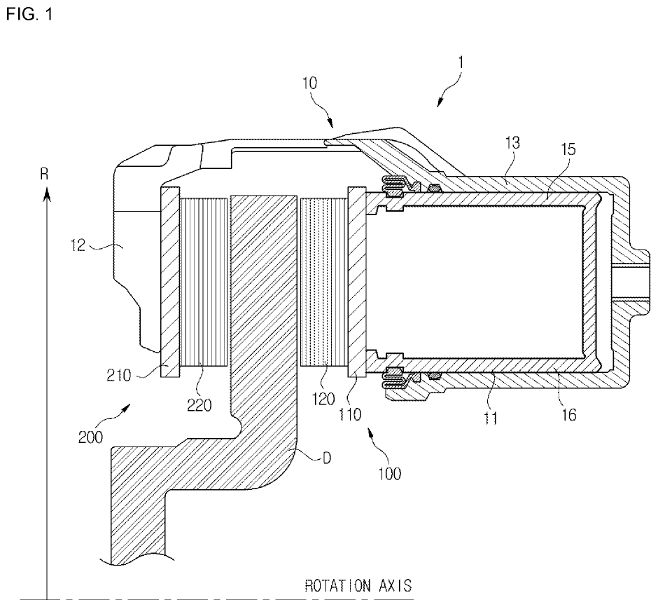

FIG. 1 schematically shows a brake system according to an embodiment of the disclosure.

Referring to FIG. 1, a brake system 1 according to the disclosure may include a carrier (not shown) in which a pair of pad plates 110 and 210 are installed in such a way as to be movable forward and backward to press a disc D rotating together with a wheel (not shown) of a vehicle, a caliper housing 10 slidably installed in the carrier and including a cylinder 13, and a piston 11 installed in the cylinder 13 in such a way as to be movable forward and backward with respect to the cylinder 13.

The pair of pad plates 110 and 210 may include an inner pad plate 110 that is in contact with the piston 11 and an outer pad plate 210 that is in contact with a finger portion (which will be described below) 12 of the caliper housing 10. The pair of pad plates 110 and 210 may be installed in the carrier fixed to a vehicle body in such a way as to be movable forward and backward toward both side surfaces of the disc D. Also, friction pads 120 and 220 may be respectively attached to surfaces of the pad plates 110 and 210 facing the disc D. As such, the friction pads 120 and 220 may be respectively attached to the pad plates 110 and 210 to form an inner brake pad 100 and an outer brake pad 200.

The caliper housing 10 may be slidably installed in the carrier. More specifically, the caliper housing 10 may include the cylinder 13 in which the piston 11 is movable forward and backward, and the finger portion 12 formed at a front portion of the caliper housing 10 and bent downward to operate the outer brake pad 200. The finger portion 12 and the cylinder 13 may be integrated into one body.

When braking hydraulic pressure is supplied through an oil port provided at a rear portion of the caliper housing 10, the piston 11 provided in the cylinder 13 may press the inner brake pad 100, and the finger portion 12 provided at the front portion may press the outer brake pad 200 toward the disc D. Accordingly, the pair of brake pads 100 and 200 may press the disc D from both sides to perform braking. The brake system 1 is widely known technology, and accordingly, detailed descriptions thereof will be omitted.

According to an embodiment of the disclosure, the piston 11 may include a body portion provided in a shape of a pillar. The body portion may be provided in the shape of the pillar and installed in the cylinder 13 in such a way as to be movable forward and backward with respect to the cylinder 13. According to an embodiment of the disclosure, a front end of the piston 11, pressing the brake pad 100, may open.

A sealing member for preventing leakage of oil between an outer circumferential surface of the body portion and an inner surface of the cylinder 13 may be provided on the outer circumferential surface of the body portion. Also, a coupling groove into which a boot for preventing external foreign materials from entering between the body portion and the cylinder 13 is coupled may be provided in the outer circumferential surface of the body portion. In an inner side of the open front end of the body portion, a clip groove to which a coupling clip provided in the brake pad 100 is coupled may be provided.

According to an embodiment of the disclosure, the body portion may include a first body portion 15 provided at an outer side of the body portion in a radial direction R of the disc D, and a second body portion 16 provided at an inner side of the body portion in the radial direction R of the disc D. As shown in FIG. 1, when the brake system 1 is installed at an upper side of the disc D, the first body portion 15 may be provided at the outer side of the body portion in the radial direction R of the disc D, that is, at an upper side of the brake system 1, and the second body portion 16 may be provided at a lower side of the brake system 1.

According to an embodiment of the disclosure, the second body portion 16 may have a coefficient of elasticity that is different from that of the first body portion 15.

According to an embodiment of the disclosure, the coefficient of elasticity of the first body portion 15 may be greater than the coefficient of elasticity of the second body portion 16. That is, when the same load is applied to the first body portion 15 and the second body portion 16, the first body portion 15 may be less deformed than the second body portion 16.

That is, because the piston 11 according to the disclosure has different characteristics at the outer side of the piston 11 in the radial direction R of the disc D and at the inner side of the piston 11 in the radial direction R of the disc D, a difference may be made between an amount of deformation of the first body portion 15 and an amount of deformation of the second body portion 16 when the piston 11 presses the brake pad 100 upon braking, and the difference in amount of deformation may prevent the piston 11 from being twisted upon braking.

Alternatively, in one embodiment of the disclosure, the second body portion 16 may have a thermal property that is different from that of the first body portion 15. For example, the second body portion 16 may have a thermal expansion coefficient that is different from that of the first body portion 15.

According to an embodiment of the disclosure, the thermal expansion coefficient of the first body portion 15 may be smaller than the thermal expansion coefficient of the second body portion 16. That is, when the temperature is increased by braking the first body portion 15 may deform less than the second body portion 16.

That is, because the piston 11 according to the disclosure has different characteristics at the outer side of the piston 11 in the radial direction R of the disc D and at the inner side of the piston 11 in the radial direction R of the disc D, a difference may be made between an amount of deformation of the first body portion 15 and an amount of deformation of the second body portion 16 when the temperature is increased upon braking, and the difference in amount of deformation may prevent the piston 11 from being twisted upon braking.

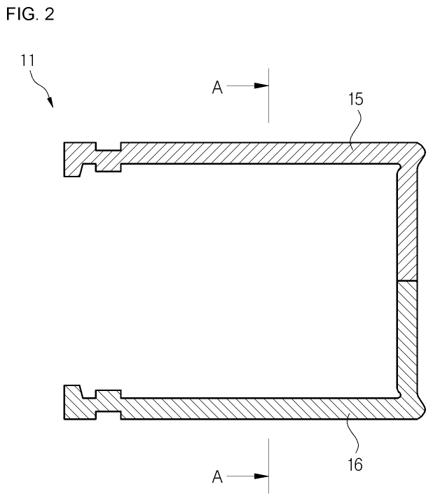

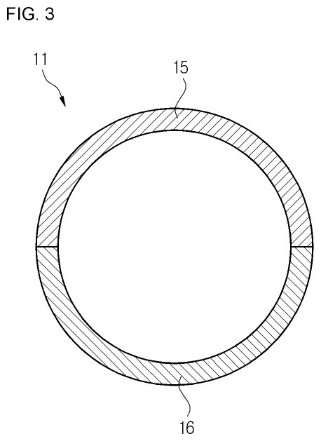

FIG. 2 schematically shows a cross section in vertical direction of a brake piston according to a first embodiment of the disclosure, and FIG. 3 schematically shows a cross section in horizontal direction A-A of the brake piston according to the first embodiment of the disclosure.

Referring to FIGS. 2 and 3, in the brake piston 11 according to the first embodiment of the disclosure, the first body portion 15 may be bonded with the second body portion 16 to form the body portion. That is, the first body portion 15 may form one side of the body portion, the second body portion 16 may form another side of the body portion, and the body portion may be formed by bonding the first body portion 15 with the second body portion 16.

As shown in FIGS. 2 and 3, the first body portion 15 may be symmetrical to the second body portion 16. In this case, the first body portion 15 and the second body portion 16 may be made of different materials to have different coefficients of elasticity.

As such, in the piston 11 according to the first embodiment of the disclosure, the first body portion 15 and the second body portion 16 may be formed with different materials to have different characteristics, thereby preventing the piston 11 from being twisted upon braking.

The first body portion 15 and the second body portion 16 of the piston 11 may be formed with materials such as Steel, Aluminum, Standard Gray Cast Iron, Gray Cast Iron GG150, Gray Cast Iron GG180, SG Iron, Duroplast or Thermo-plast.

At room temperature (20° C.), Steel has an elastic modulus (E) of 210.000 MPa, a Poisson's ratio of 0.30 and a thermal expansion coefficient of 1.1*E−05 1/° K. Aluminum has an elastic modulus (E) of 71.000 MPa, Poisson's Ratio=0.33, and a thermal expansion coefficient of 2.5*E−05 1/° K. Standard Gray Cast Iron has an elastic modulus (E) of 105.000 MPa, Poisson's Ratio=0.25 and a thermal expansion coefficient of 2.2*E−05 1/° K. Gray Cast Iron GG150 has an elastic modulus (E) of 100.000 MPa, a Poisson's ratio of 0.25 and a thermal expansion coefficient of 2.2*E−05 1/° K. Gray Cast Iron GG180 has an elastic modulus (E) of 110.000 MPa, a Poisson's ratio of 0.24 and a thermal expansion coefficient of 2.3*E−05 1/° K. SG Iron has an elastic modulus (E) of 165.000 MPa, a Poisson's ratio of 0.28 and a thermal expansion coefficient of 2.3*E−05 1/° K. Duroplast has an elastic modulus (E) of 5.000 MPa, a Poisson's ratio of 0.38 and a thermal expansion coefficient of 20*E−05 1/° K. Thermo-plast has an elastic modulus (E) of 4.000 MPa, a Poisson's ratio of 0.35 and a thermal expansion coefficient of 25*E−05 1/° K.

According to an embodiment of the disclosure, the first body portion 15 may be formed with Grey Cast and the second body portion 16 may be formed with Aluminum, Duroplast or Thermo-plast so that the thermal expansion coefficient of the first body portion 15 may be smaller than the thermal expansion coefficient of the second body portion 16.

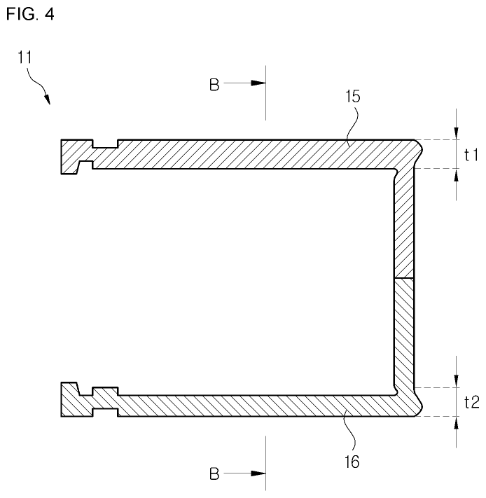

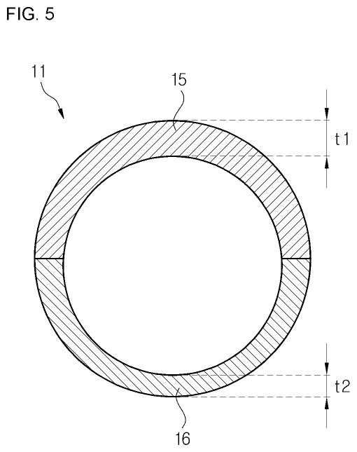

FIG. 4 schematically shows a cross section in vertical direction of a brake piston according to a second embodiment of the disclosure, and FIG. 5 schematically shows a cross section in horizontal direction B-B of the brake piston according to the second embodiment of the disclosure.

Referring to FIGS. 4 and 5, in a brake piston 11 according to the second embodiment of the disclosure, a first body portion 15 and a second body portion 16 may have different cross sectional areas in an axial direction. As shown in FIGS. 4 and 5, in the brake piton 11 of which a front end opens, a thickness t1 of the first body portion 15 may be different from a thickness t2 of the second body portion 16. Due to the difference in thickness, a cross sectional area in axial direction of the first body portion 15 may become different from a cross sectional area in axial direction of the second body portion 16, as shown in FIG. 5.

According to the second embodiment of the disclosure, the first body portion 15 and the second body portion 16 may be made of the same material. Because the first body portion 15 and the second body portion 16 have different cross sectional areas in the axial direction although the first body portion 15 and the second body portion 16 are made of the same material, the first body portion 15 and the second body portion 16 may show different deformation characteristics when the first body portion 15 and the second body portion 16 are pressed in the axial direction.

Alternatively, according to the second embodiment of the disclosure, the first body portion 15 and the second body portion 16 may be made of different materials. The first body portion 15 and the second body portion 16 may have different cross sectional areas in the axial direction and be made of different materials. Accordingly, when the first body portion 15 and the second body portion 16 are pressed in the axial direction, the first body portion 15 and the second body portion 16 may show different deformation characteristics.

As such, according to the second embodiment of the disclosure, because the first body portion 15 and the second body portion 16 of the piston 11 have different cross sectional areas in the axial direction, the first body portion 15 and the second body portion 16 may have different characteristics, thereby preventing the piston 11 from being twisted upon braking.

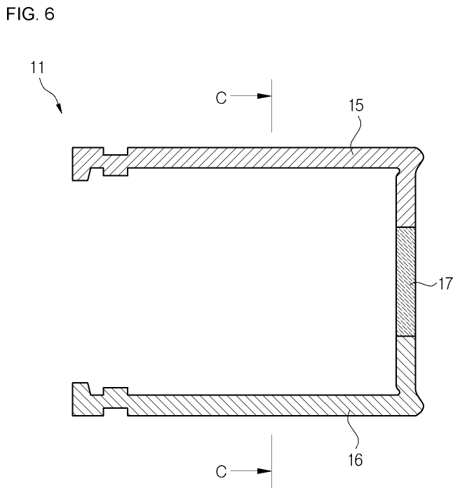

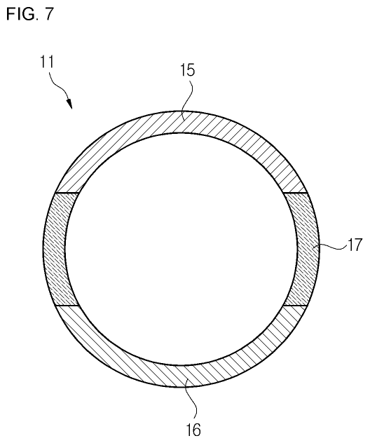

FIG. 6 schematically shows a cross section in vertical direction of a brake piston according to a third embodiment of the disclosure, and FIG. 7 schematically shows a cross section in horizontal direction C-C of the brake piston according to the third embodiment of the disclosure.

Referring to FIGS. 6 and 7, in the third embodiment of the disclosure, a brake piston 11 may further include, in addition to a first body portion 15 and a second body portion 16, a third body portion 17 positioned between the first body portion 15 and the second body portion 16. In this case, the third body portion 17 may be bonded with the first body portion 15 and the second body portion 16 to form a body portion. In this case, the first body portion 15 may be bonded with the third body portion 17, and the second body portion 16 may be bonded with the third body portion 17. That is, the third body portion 17 may form a center portion of the body portion, the first body portion 15 may form one side of the body portion, the second body portion 16 may form another side of the body portion, and accordingly, the first body portion 15 and the second body portion 16 may be boned with the third body portion 17 to thereby form the body portion.

As shown in FIGS. 6 and 7, the first body portion 15 may be symmetrical to the second body portion 16. In this case, the first body portion 15 and the second body portion 16 may be made of different materials to have different coefficients of elasticity.

Also, the third body portion 17 may have a coefficient of elasticity that is different from those of the first body portion 15 and the second body portion 16. That is, the first body portion 15, the second body portion 16, and the third body portion 17 may have different coefficients of elasticity.

According to an embodiment of the disclosure, the first body portion 15, the second body portion 16 and the third body portion 17 of the piston 11 may be formed with materials such as Steel, Aluminum, Standard Gray Cast Iron, Gray Cast Iron GG150, Gray Cast Iron GG180, SG Iron, Duroplast or Thermo-plast.

According to an embodiment of the disclosure, the coefficient of elasticity of the first body portion 15 may be greater than the coefficient of elasticity of the third body portion 17, and the coefficient of elasticity of the third body portion 17 may be greater than the coefficient of elasticity of the second body portion 16. When the same load is applied to the third body portion 15, the second body portion 16, and the third body portion 17, the first body portion 15 may be less deformed than the third body portion 17, and the third body portion 17 may be less deformed than the second body portion 16.

That is, because the piston 11 according to the disclosure has different characteristics at the outer side in the radial direction R of the disc D and at the inner side in the radial direction of the disc D, the first body portion 15, the third body portion 17, and the second body portion 16 may be deformed by different amounts of deformation when the piston 11 presses the brake pad 100 upon braking, and the difference in amount of deformation may prevent the piston 11 from being twisted upon braking.

In this case, the first body portion 15, the second body portion 16, and the third body portion 17 may be made of different materials to have different coefficients of elasticity.

As such, according to the third embodiment of the disclosure, the first body portion 15, the second body portion 16, and the third body portion 17 of the piston 11 may be made of different materials to have different characteristics, and accordingly, the piston 11 may be prevented from being twisted upon braking.

In the brake piston and the brake system according to an embodiment of the disclosure, the brake piston may be prevented from being twisted upon braking.

What is claimed is:

1. A brake piston provided in a brake system of a vehicle and pressing a brake pad to a disc by braking hydraulic pressure, the brake piston comprising:
a body portion installed in a cylinder provided in a caliper housing, being in a shape of a pillar, and configured to be movable forward and backward,
wherein the body portion comprises:
a first body portion provided at an outer side of the body portion in a radial direction of the disc; and
a second body portion provided at an inner side of the body portion in the radial direction of the disc and having a coefficient of elasticity that is different from a coefficient of elasticity of the first body portion.

2. The brake piston of claim 1, wherein the first body portion is bonded with the second body portion to form the body portion.

3. The brake piston of claim 1, wherein the first body portion and the second body portion are made of different materials.

4. The brake piston of claim 1, wherein a cross sectional area of the first body portion in an axial direction is different from a cross sectional area of the second body portion in the axial direction.

5. The brake piston of claim 1, wherein the coefficient of elasticity of the first body portion is greater than the coefficient of elasticity of the second body portion.

6. The brake piston of claim 1, wherein the body portion further includes a third body portion positioned between the first body portion and the second body portion.

7. The brake piston of claim 6, wherein the first body portion and the second body portion are bonded with the third body portion to form the body portion.

8. The brake piston of claim 6, wherein a coefficient of elasticity of the third body portion is different from the coefficients of elasticity of the first body portion and the second body portion.

9. The brake piston of claim 8, wherein the coefficient of elasticity of the first body portion is greater than the coefficient of elasticity of the third body portion, and
the coefficient of elasticity of the third body portion is greater than the coefficient of elasticity of the second body portion.

10. The brake piston of claim 6, wherein the first body portion, the second body portion, and the third body portion are made of different materials.

11. A brake system comprising:
a carrier in which a pair of brake pads are installed to be movable forward and backward;
a caliper housing slidably installed in the carrier, wherein a cylinder is provided in the caliper housing; and
a piston installed in the cylinder and configured to be movable forward and backward,
wherein the piston comprises a body portion being in a shape of a pillar, and
the body portion comprises:
a first body portion provided at an outer side of the body portion in a radial direction of the disc; and
a second body portion provided at an inner side of the body portion in the radial direction of the disc and having a coefficient of elasticity that is different from a coefficient of elasticity of the first body portion.

12. The brake system of claim 11, wherein the first body portion is bonded with the second body portion to form the body portion.

13. The brake system of claim 11, wherein the first body portion and the second body portion are made of different materials.

14. The brake system of claim 11, wherein a cross sectional area of the first body portion in an axial direction is different from a cross sectional area of the second body portion in the axial direction.

15. The brake system of claim 11, wherein the coefficient of elasticity of the first body portion is greater than the coefficient of elasticity of the second body portion.

16. The brake system of claim 11, wherein the body portion further includes a third body portion positioned between the first body portion and the second body portion.

17. The brake system of claim 16, wherein the first body portion and the second body portion are bonded with the third body portion to form the body portion.

18. The brake system of claim 16, wherein a coefficient of elasticity of the third body portion is different from the coefficients of elasticity of the first body portion and the second body portion.

19. The brake system of claim 18, wherein the coefficient of elasticity of the first body portion is greater than the coefficient of elasticity of the third body portion, and
the coefficient of elasticity of the third body portion is greater than the coefficient of elasticity of the second body portion.

20. The brake system of claim 16, wherein the first body portion, the second body portion, and the third body portion are made of different materials.
